(19) United States
(12) Patent Application Publication
(10) Pub. No.: US 2017/0193464 A1
(43) Pub. Date: Jul. 6, 2017

(54) Protocol utilizing bitcoin blockchain for maintaining independently proposed and approved set contents

(71) Applicant: Justin SHER, Woodside, CA (US)

(72) Inventor: Justin SHER, Woodside, CA (US)

(21) Appl. No.: 15/383,255

(22) Filed: Dec. 19, 2016

Related U.S. Application Data
(60) Provisional application No. 62/269,928, filed on Dec. 18, 2015.

(51) Int. Cl. G06Q 20/06; H04L 9/32; G06Q 20/14; H04L 9/06

(52) U.S. Cl. CPC G06Q 20/065; H04L 9/0637; H04L 9/32; G06Q 20/14

(57) ABSTRACT

A ‘Chainset’ protocol allows anyone willing to pay a standard Bitcoin transaction fee the ability to create a set that they can approve and reject submissions to and that any user of the blockchain can, for a set fee, propose additions to. A client, having only access to the blockchain or a Chainset server that analyzes and summarizes the blockchain and a hash identified distributed object store, such as the bittorrent protocol, will be able to read an approved set of document hashes, and through the distributed object store, an approved set of documents. The economics built into the payment mechanics for proposal, approval and rejection allow for a wide variety of possible use cases.

The Bitcoin blockchain is a highly successful implementation of cryptocurrency and byzantine consensus. The combination of proof-of-work distributed consensus and transaction fees has rendered it resistant to most attacks and provided long term durability and verifiability of blockchain transactions. The recently introduced OP_RETURN functionality has allowed storage of up to 80 bytes of data at a time on the blockchain with the payment of a transaction fee. While it would be impractical to store large amounts of data on the blockchain, it is possible to use the blockchain to store small structured transactional conversations. Many services have been created to utilize this functionality to refer to off- chain resources that implement blockchain like services with added features (e.g Factom).

A fundamental computer science data structure that could implement many diverse use cases is the set. Unstructured control of any set in a distributed peer to peer context eventually leads to problems with spam and poor quality content. This problem is similar to the well known ‘tragedy of the commons’ problem in game theory. In this problem, a shared resource available to multiple parties with conflicting interests is over-utilized to the detriment of the sum of common shared interests.

Ownership of the commons is a well known way to remediate some of the problems involved with the commons. Issues with ownership can arise when there is only a small number of owners of property that can be owned relative to the population it serves. In consideration of ownership and the need for broad ownership of sets on the blockchain, we propose a ‘Chainset’ protocol which allows anyone willing to pay a standard Bitcoin transaction fee the ability to create a set that they can approve and reject submissions to and that any user of the blockchain can, for a set fee, propose additions to. A client, having only access to the blockchain or a Chainset server that analyzes and summarizes the blockchain and a hash identified distributed object store, such as the bittorrent protocol, will be able to read an approved set of document hashes, and through the distributed object store, an approved set of documents. The economics built into the payment mechanics for proposal, approval and rejection allow for a wide variety of possible use cases.

Use Cases

Content Moderation (Forums)

Moderation of user generated content is a difficult problem usually requiring manual review. Many online services pay staff contractors to perform this function or the function is performed through various crowd sourcing methods. A scalable peer-to-peer system that would compensate moderators for their work would allow peer-to-peer content moderation to decentralize effectively.

Content Moderation (Academic Journals)

Content that is the product of high effort in its production and review, such as academic papers would also benefit from this system as it would, thorough fees, limit the amount of material submitted to reviewers and would properly compensate submitters of accepted material for their quality work.

Charitable giving from Individuals

Charitable giving proposals often lack transparency and often have a heavy administrative burden between givers and receivers of aid. In a Chainset oriented system, approvers of proposals could approve proposals and then funds could be automatically dispersed on a proportional or other basis to those who submitted proposals.

Distributed Resource Allocation

Smart property could listen for inclusions in Chainsets to distribute access to property. For example allowing a vehicle interlock system to unlock for a period of time for an approved user of that vehicle.

Governance

Laws could be submitted to and then approved by a parliament of interested individuals and then executed by those who subscribed to their decisions. this would help in the distributed governance of organizations such as sports or club authorities.

### DRAWINGS

For a better understanding of the present invention and an embodiment for practicing same, reference should be made to the accompanying Drawings in which:

FIG. 1 is an exemplary Flow Diagram of Chainset Creation By Chainset Creator;

FIG. 2 is an exemplary Flow Diagram of Chainset Moderation By Chainset Creator;

FIG. 3 is an exemplary Flow Diagram of Chainset Submission By Chainset Proposer;

FIG. 4 is an exemplary Flow Diagram of Chainset Construction By Chainset Observer;

FIG. 5 comprising FIGS. 5A and 5B depicts Source Code for an exemplary Chainset REST Service;

FIG. 6 comprising FIGS. 6A through-6G depicts Source Code for exemplary Chainset Local Database Operations and Chainset Evaluation; and

FIG. 7 comprising FIGS. 7A through 7J depicts Source Code for exemplary Chainset Blockchain Operations.

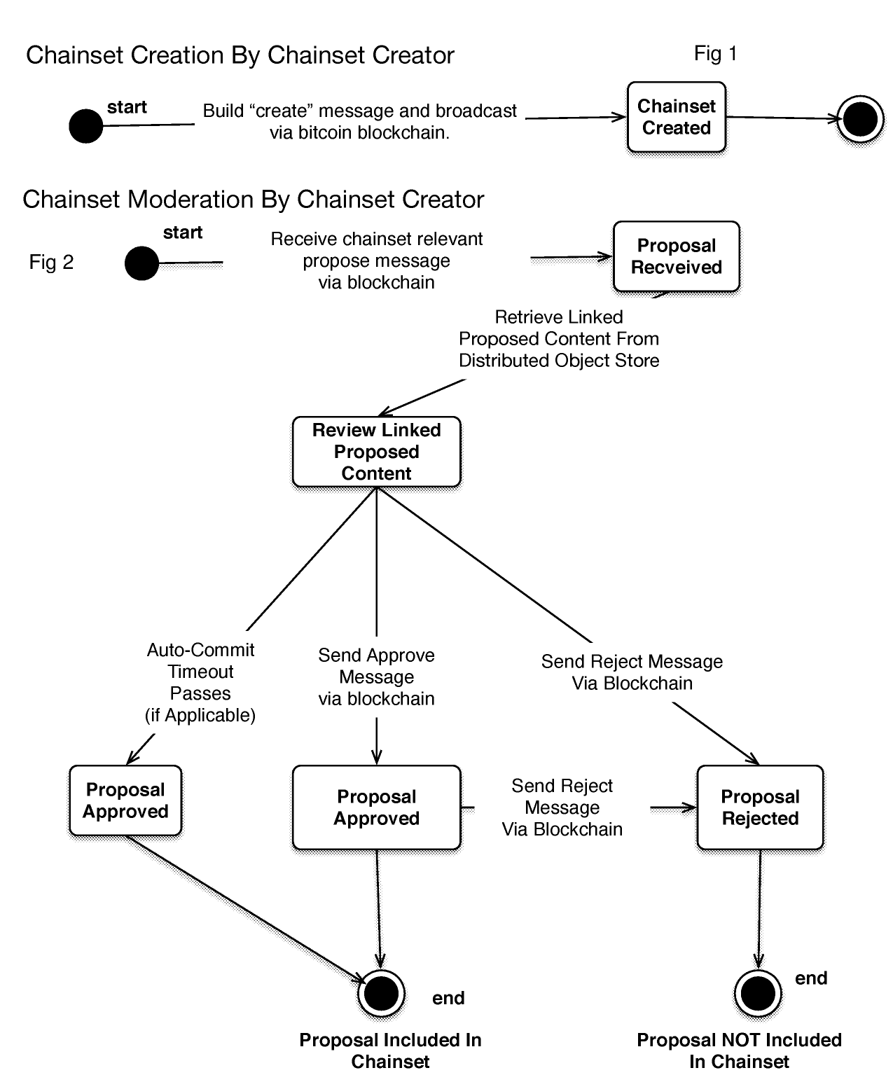

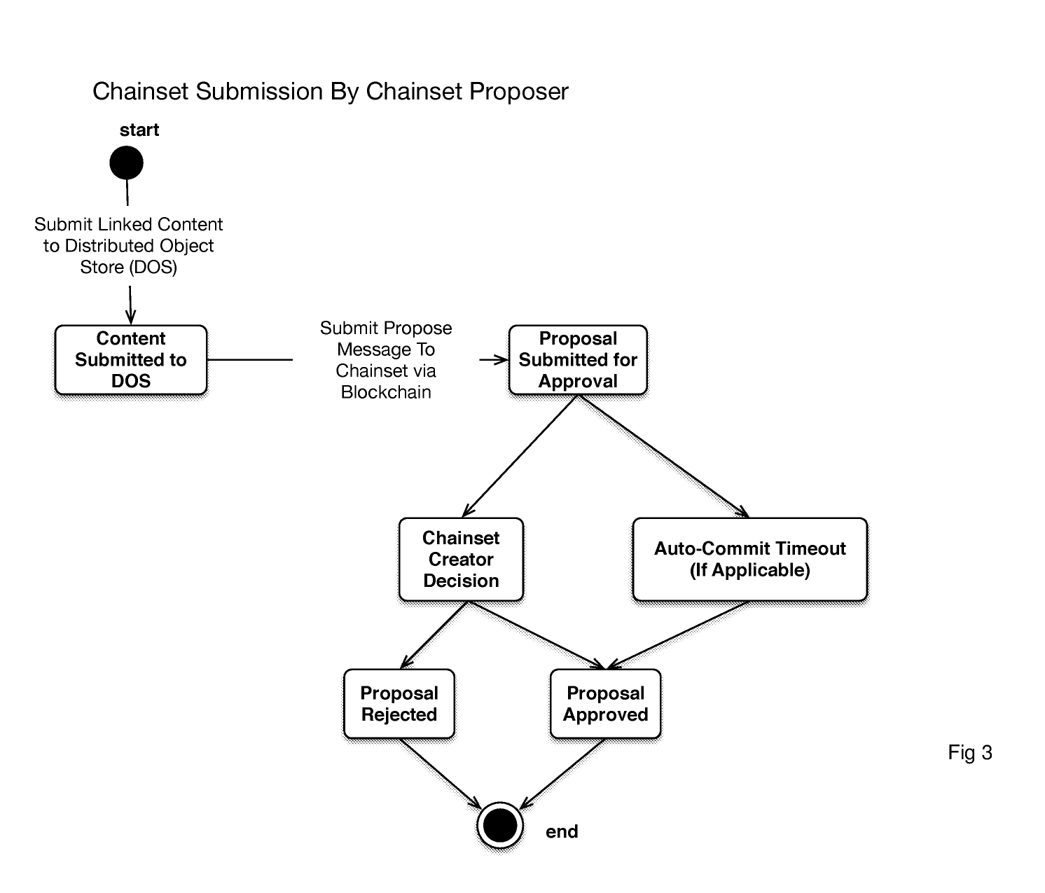

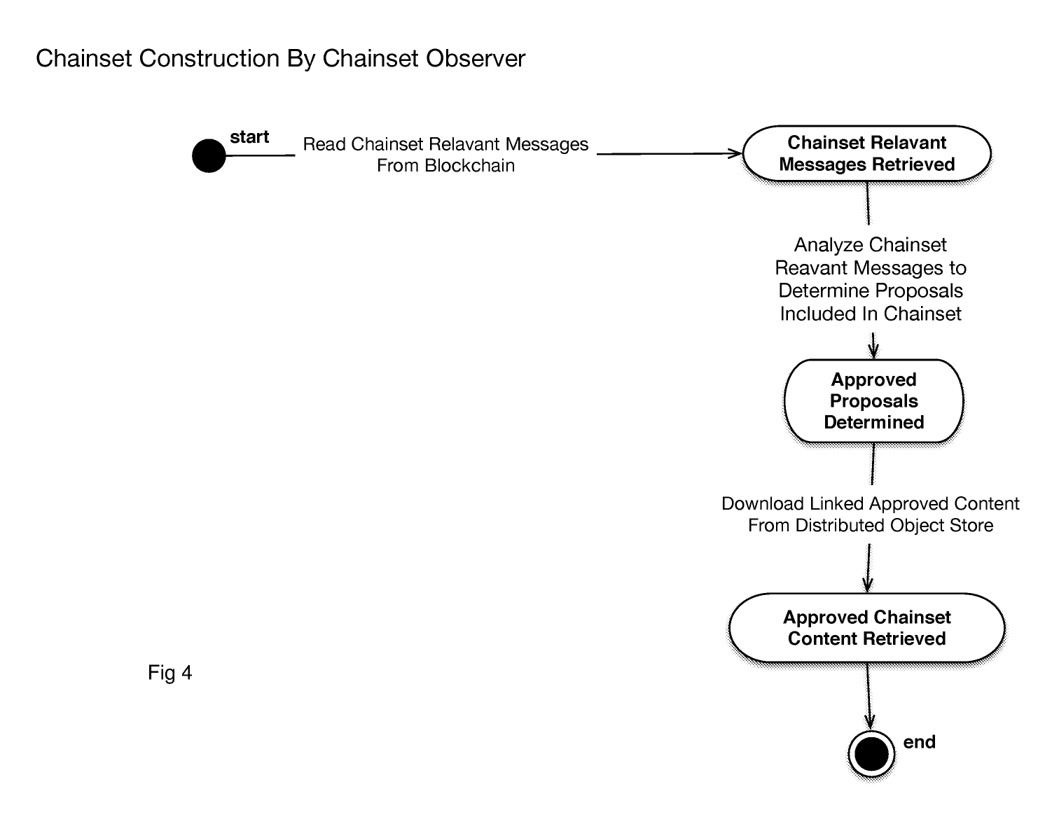

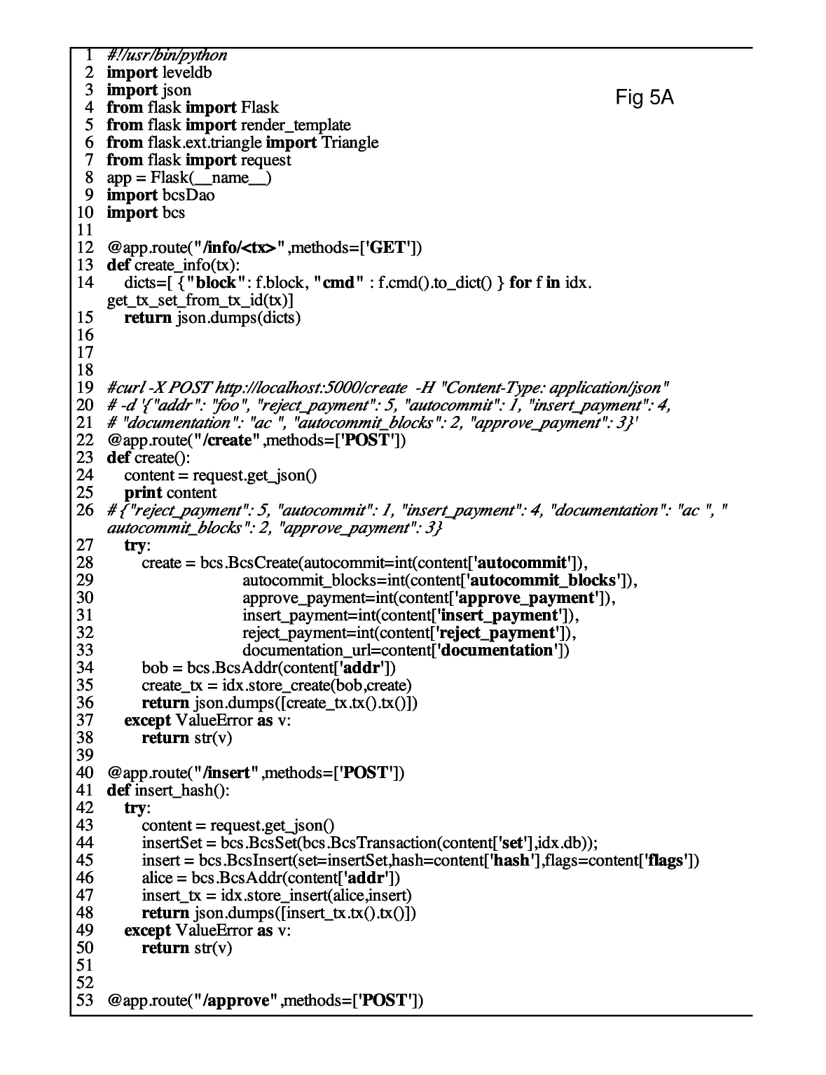

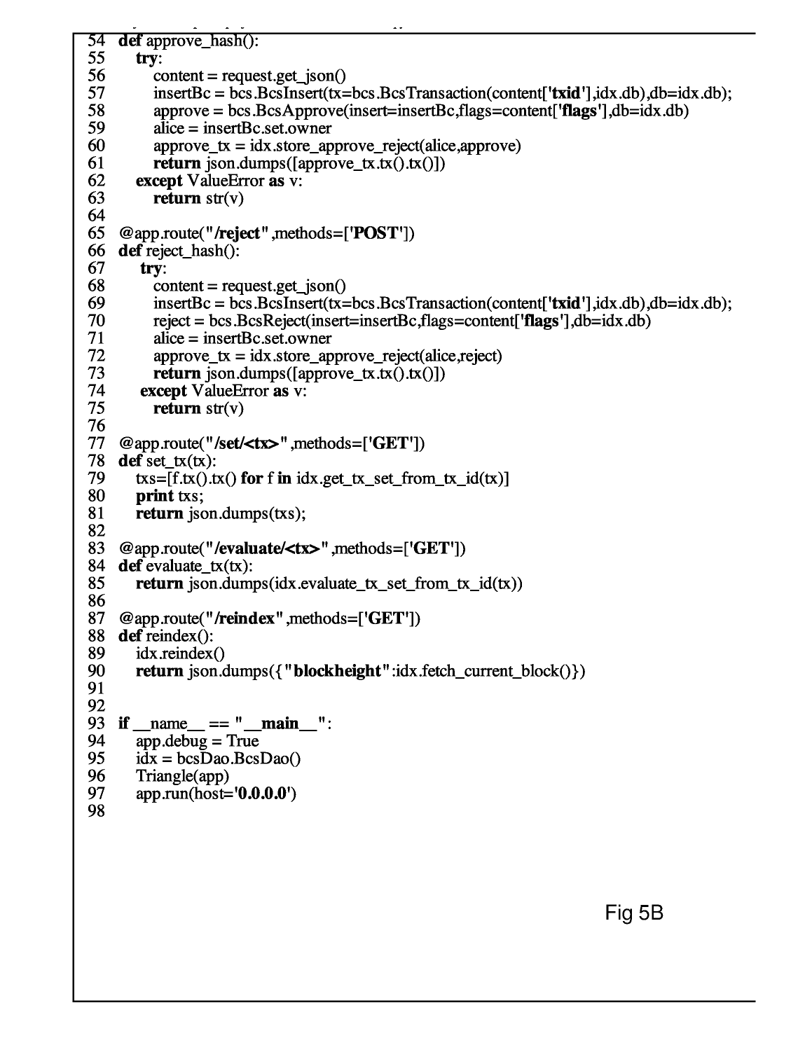

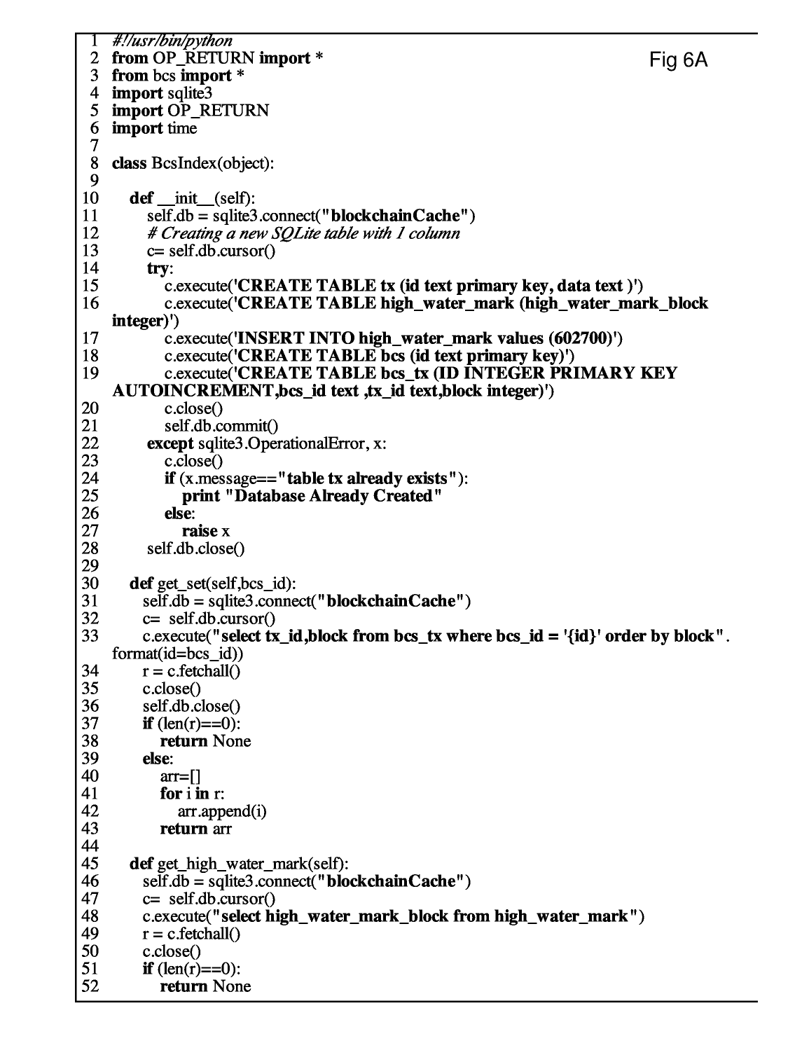

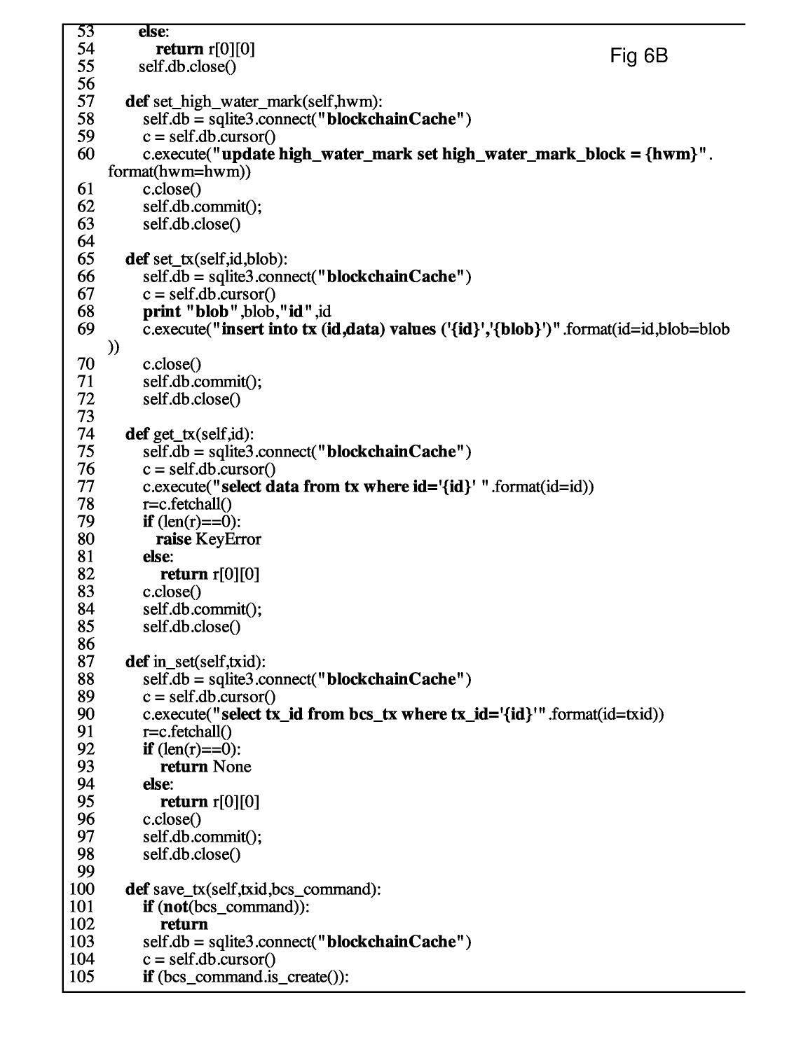

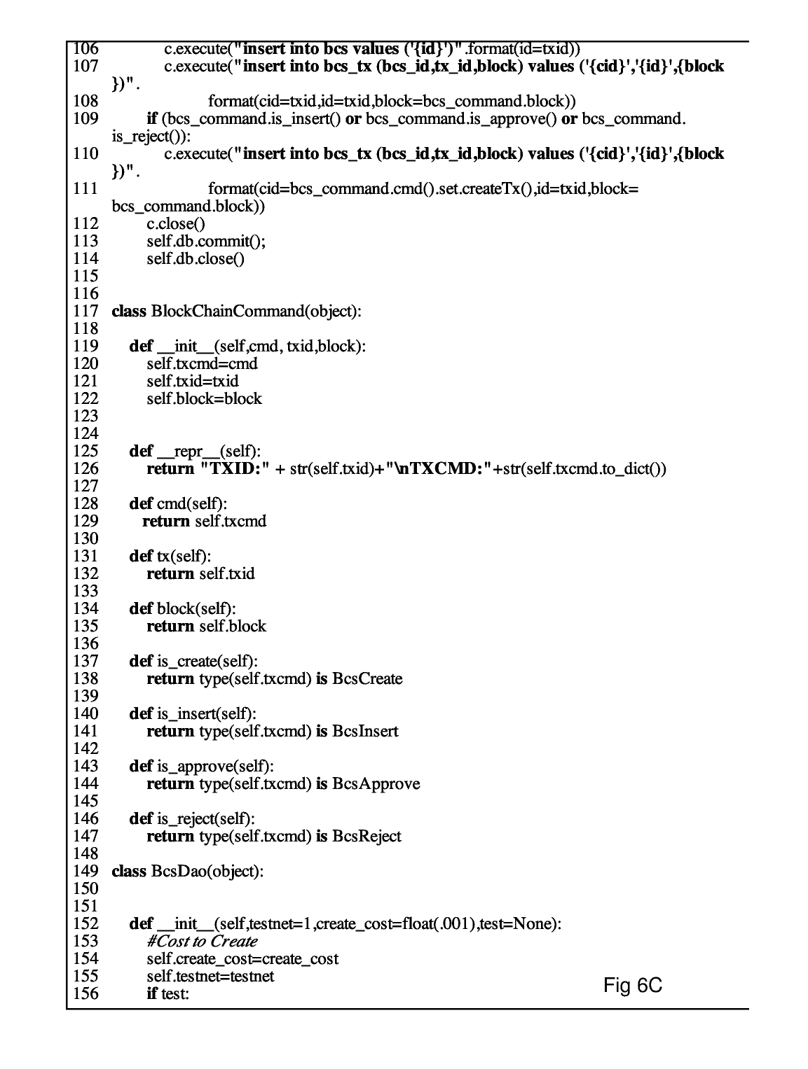

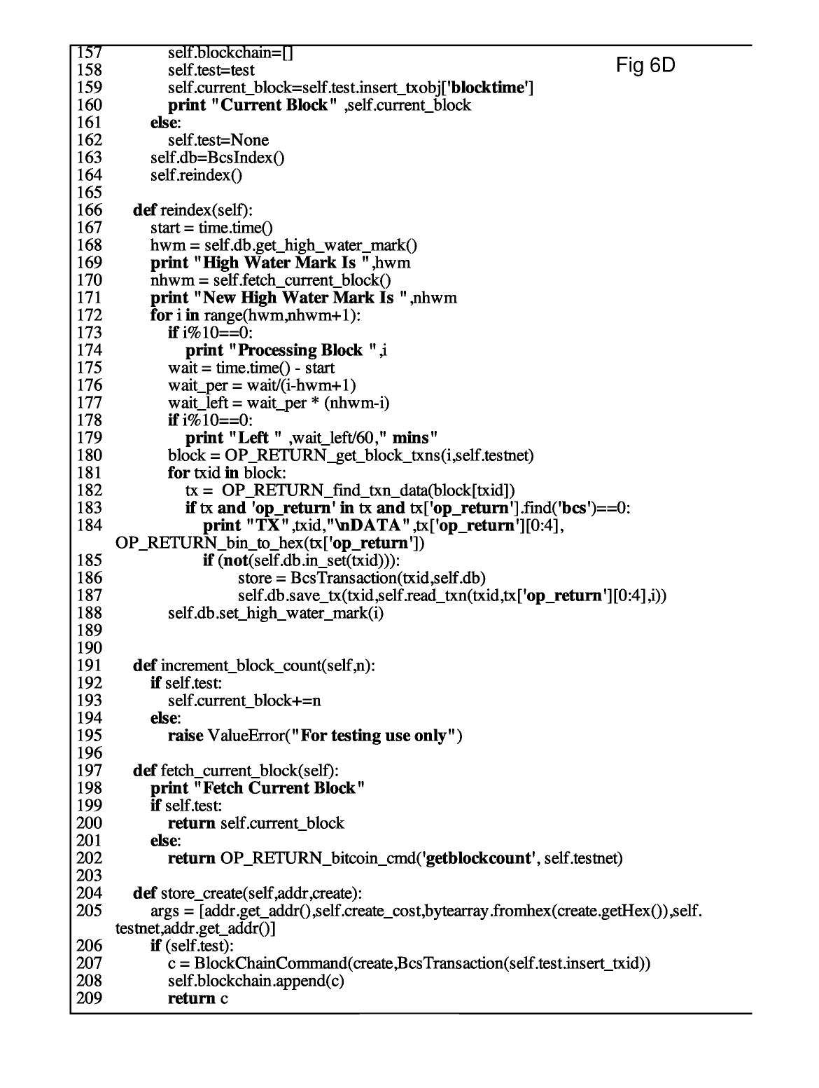

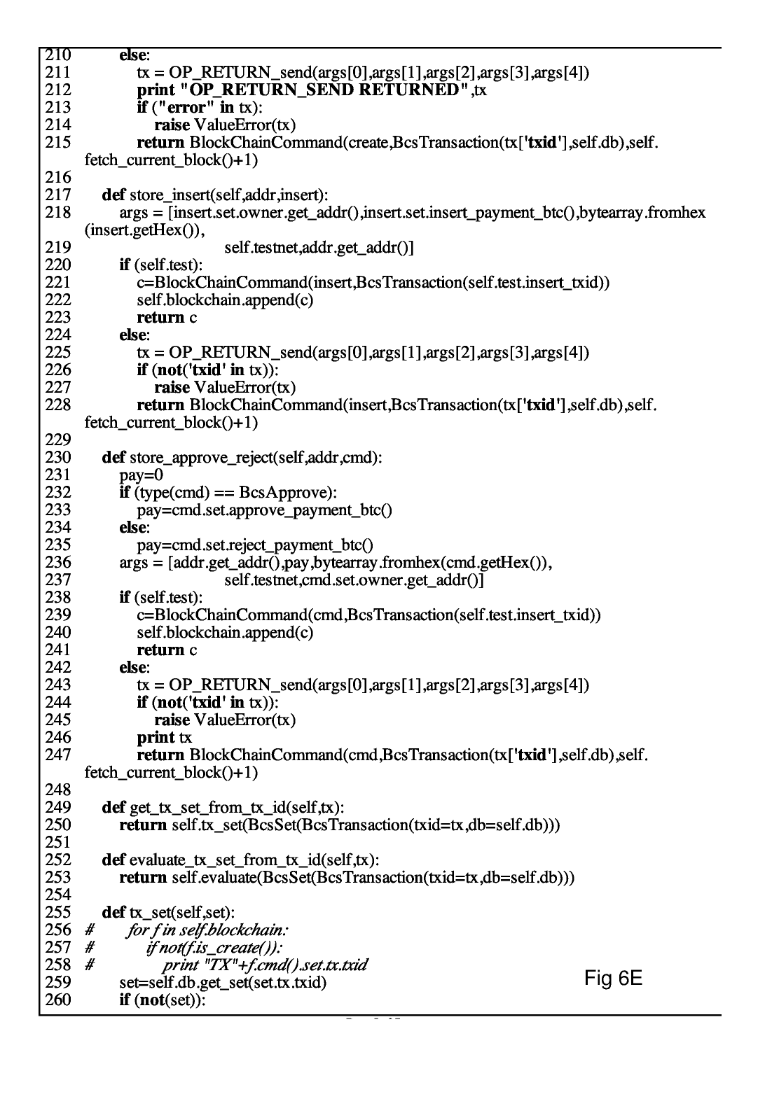

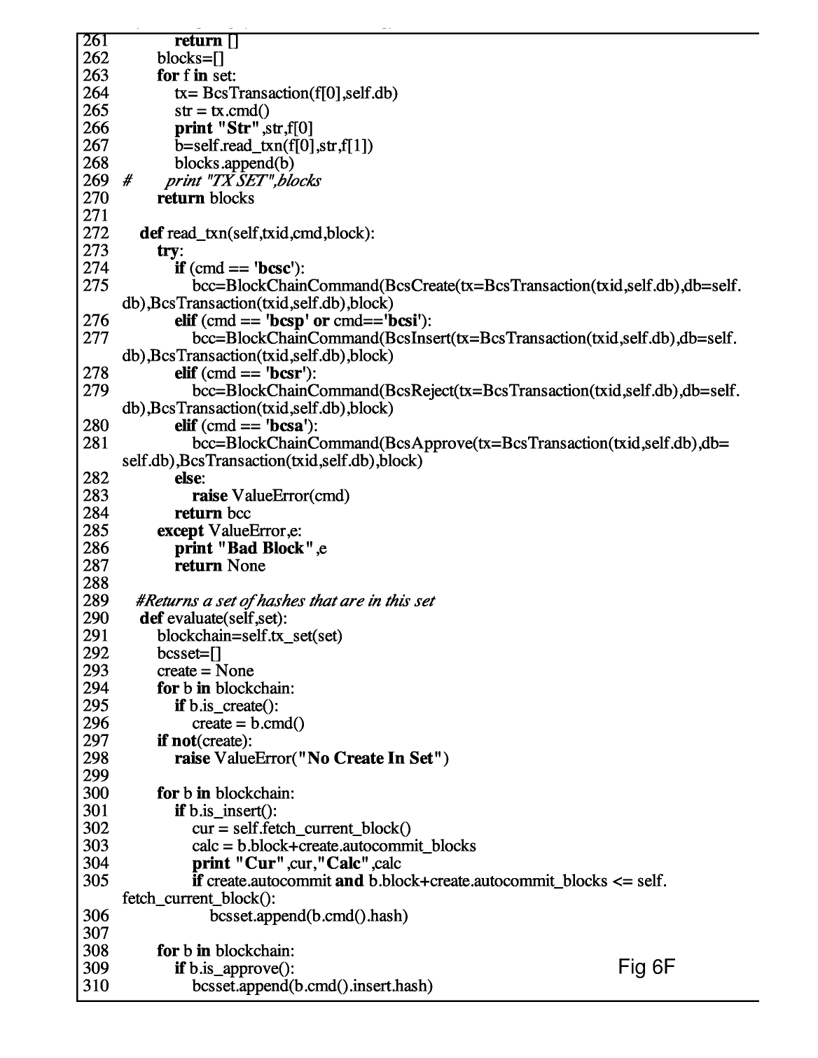

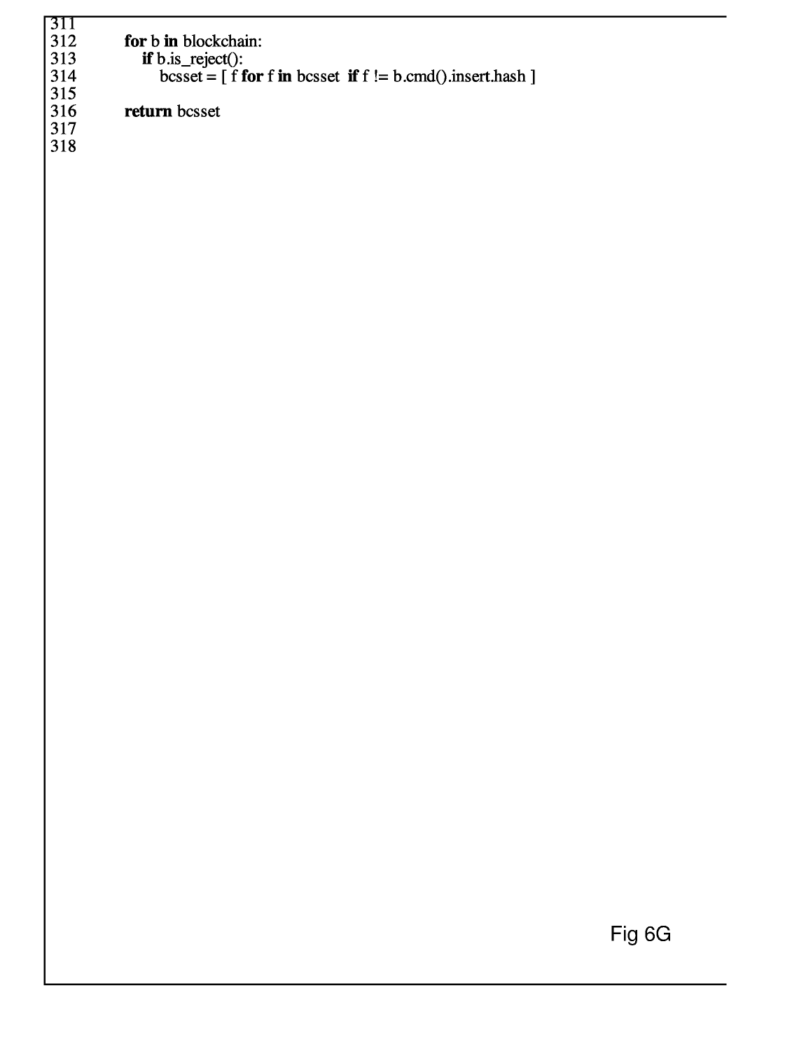

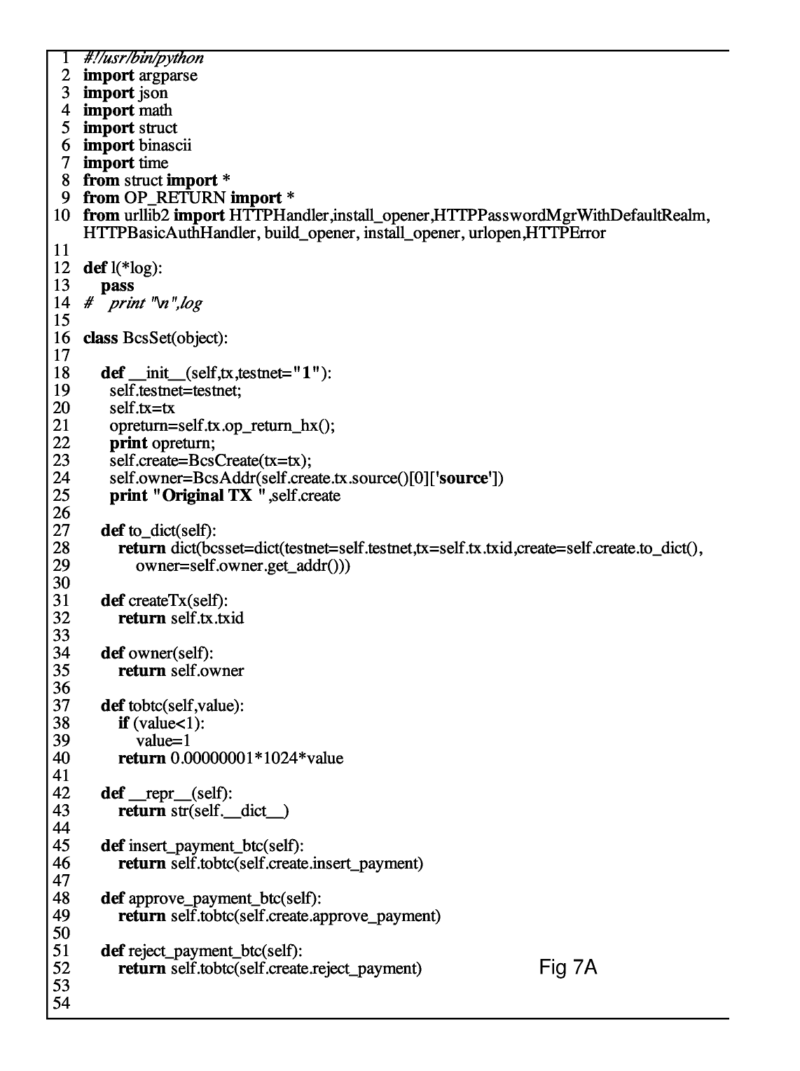

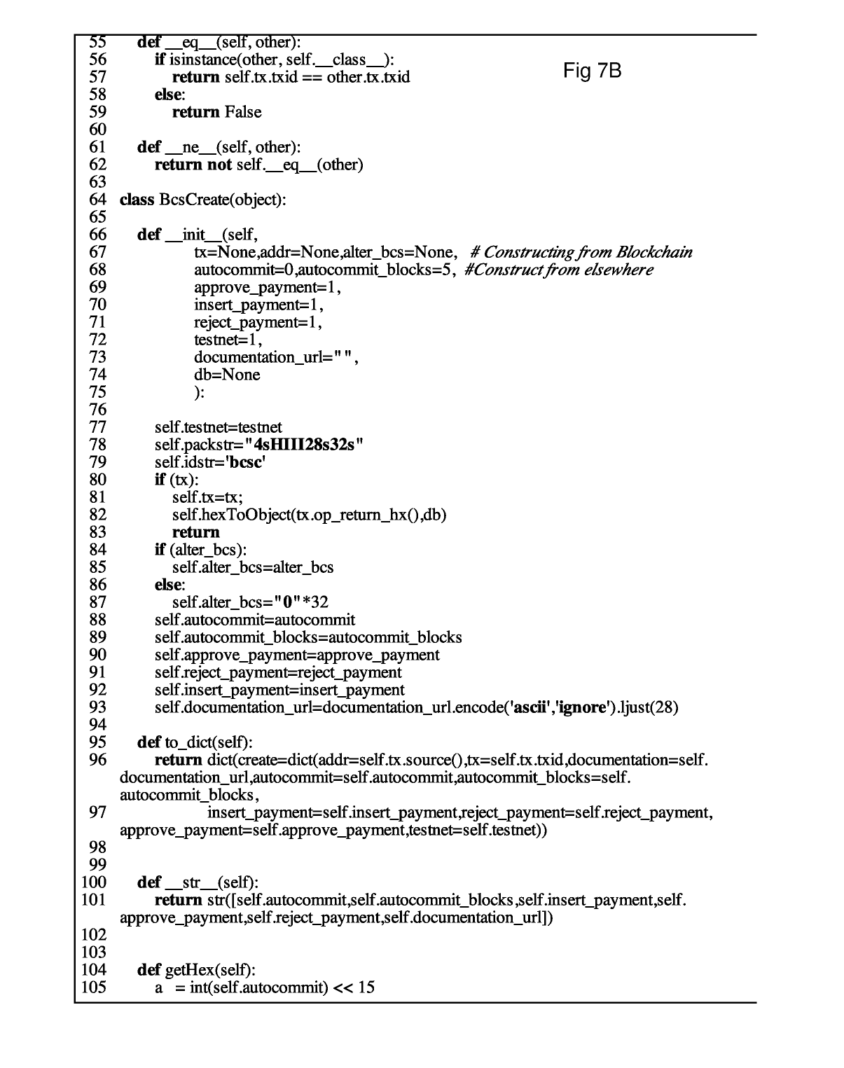

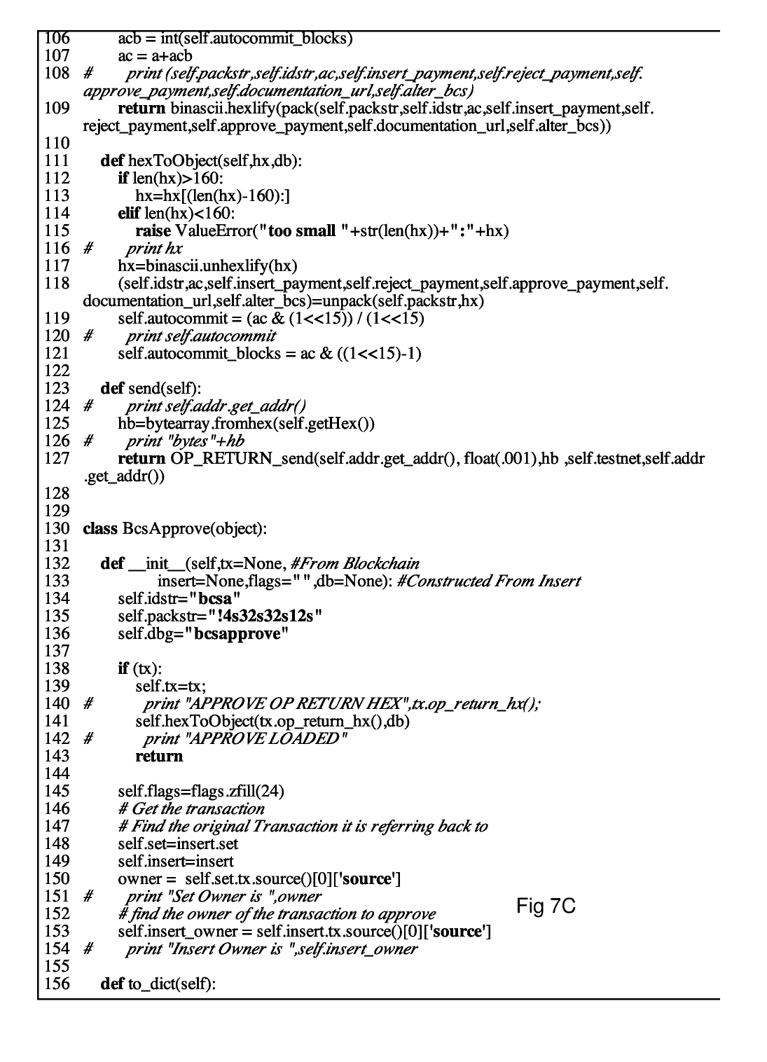

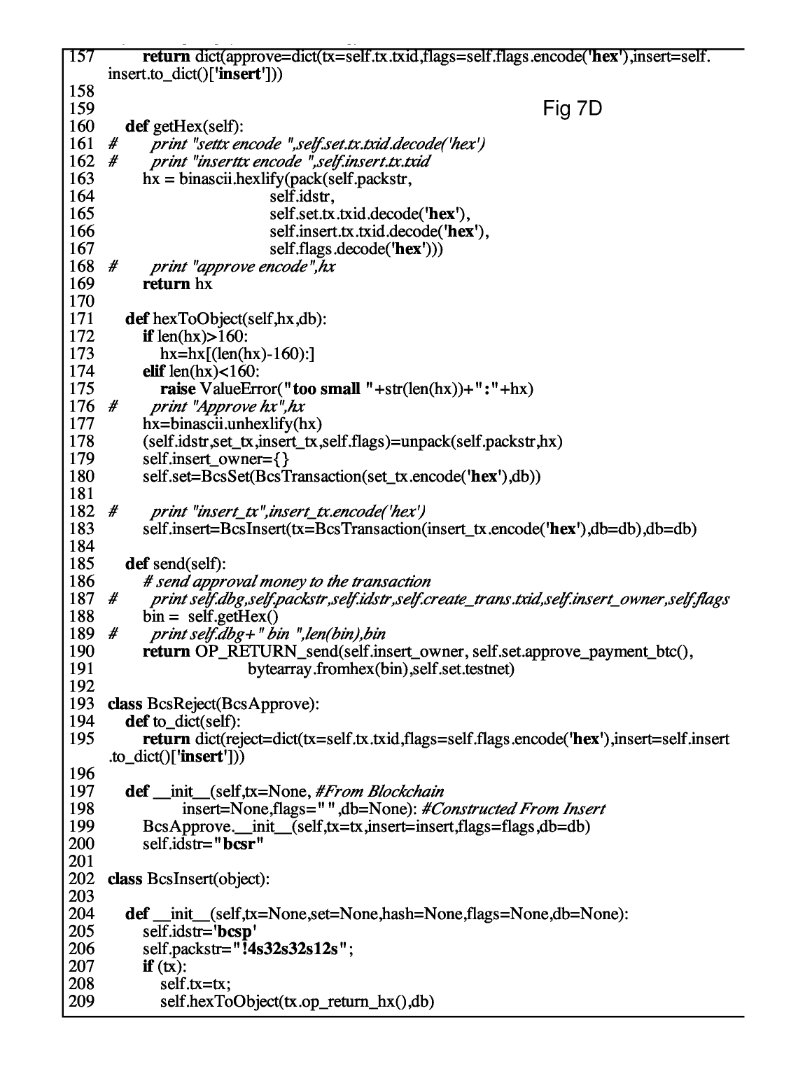

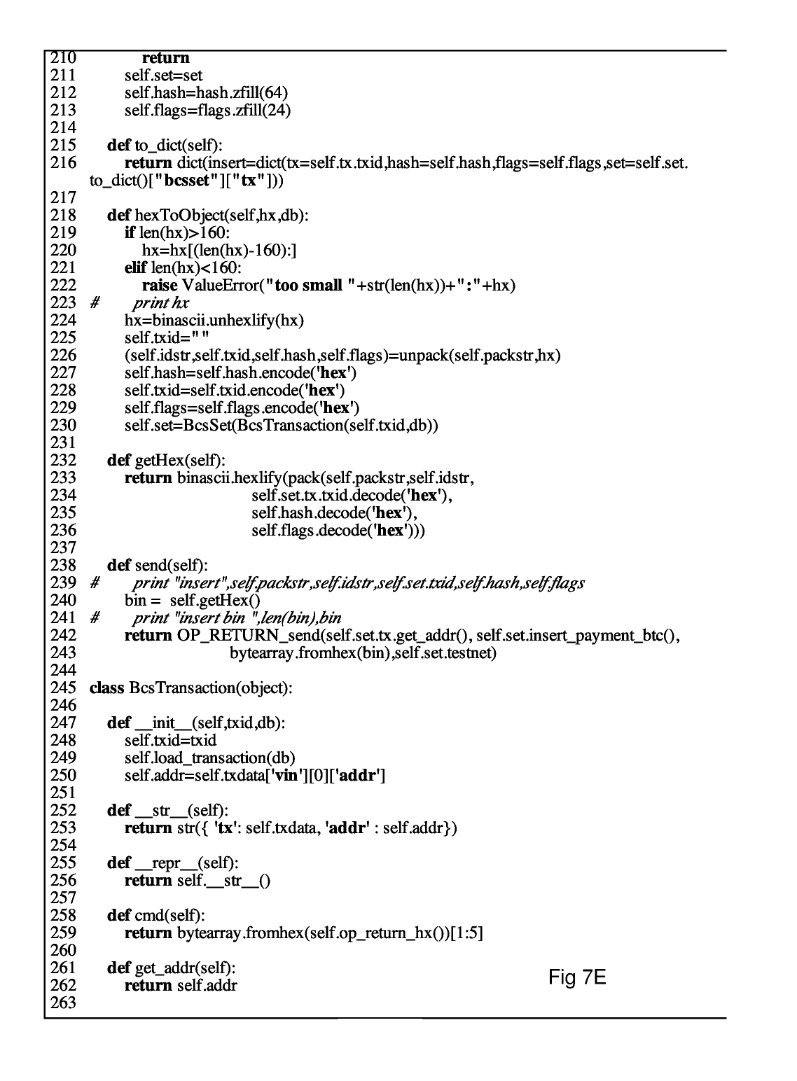

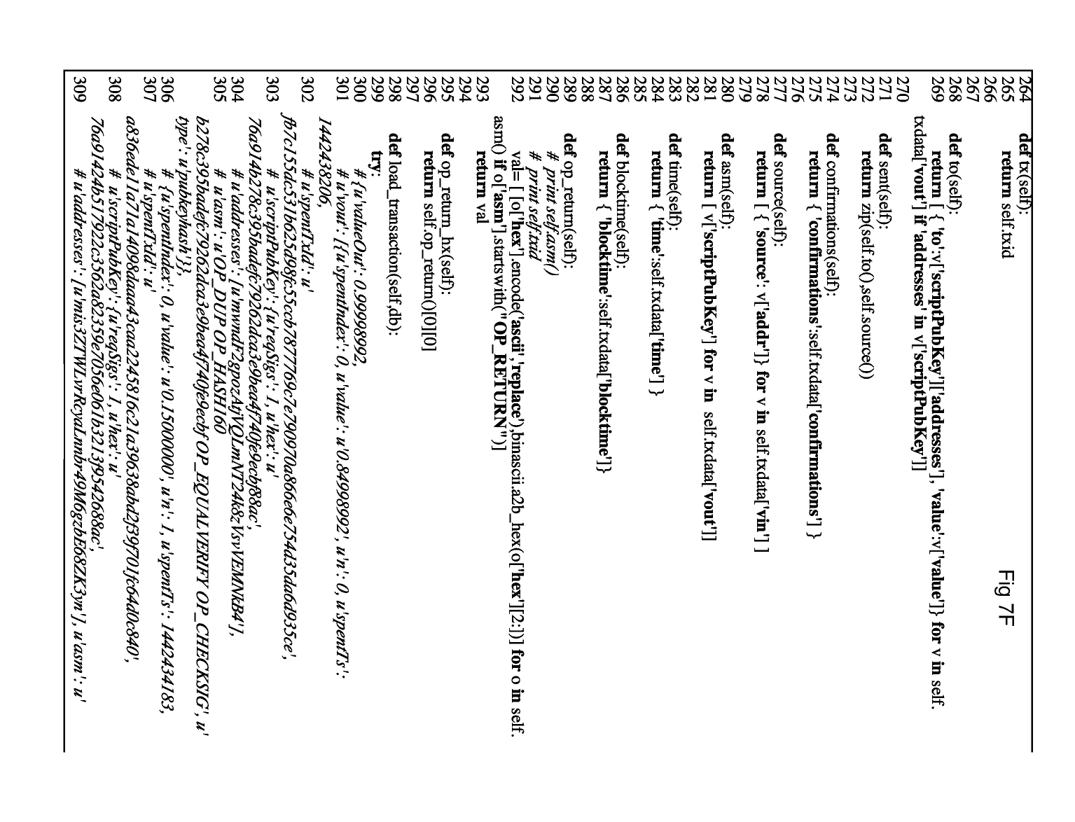

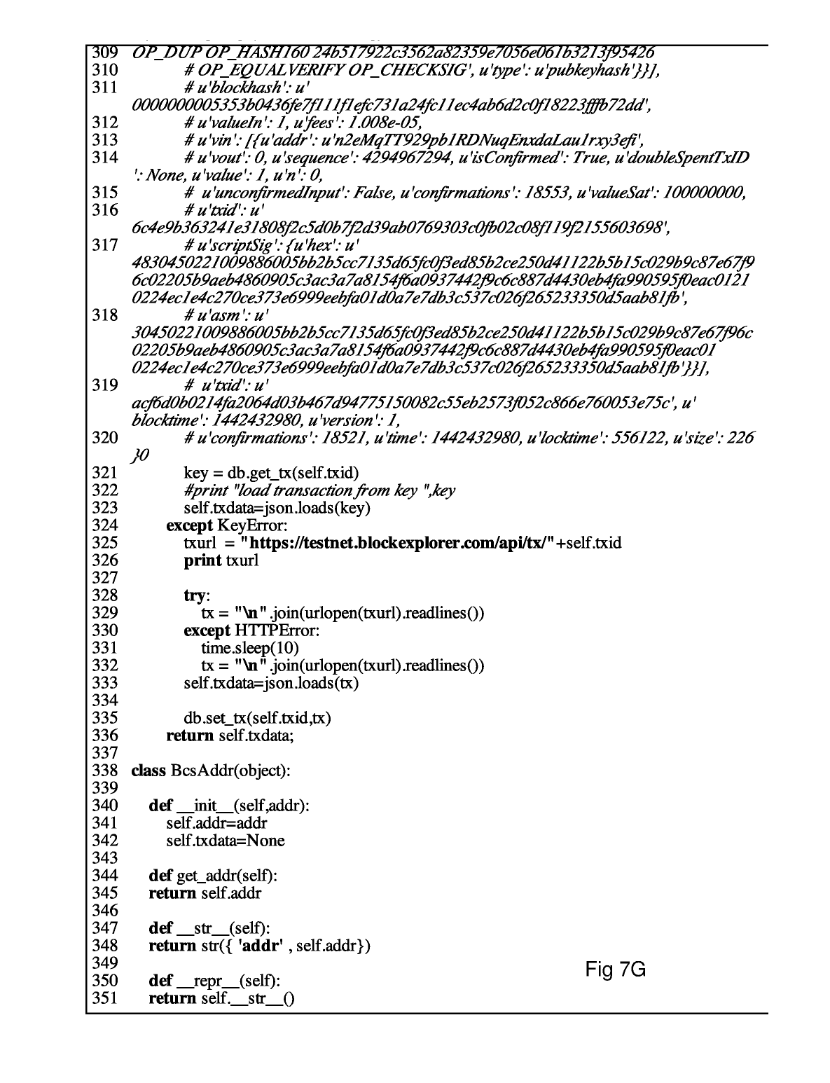

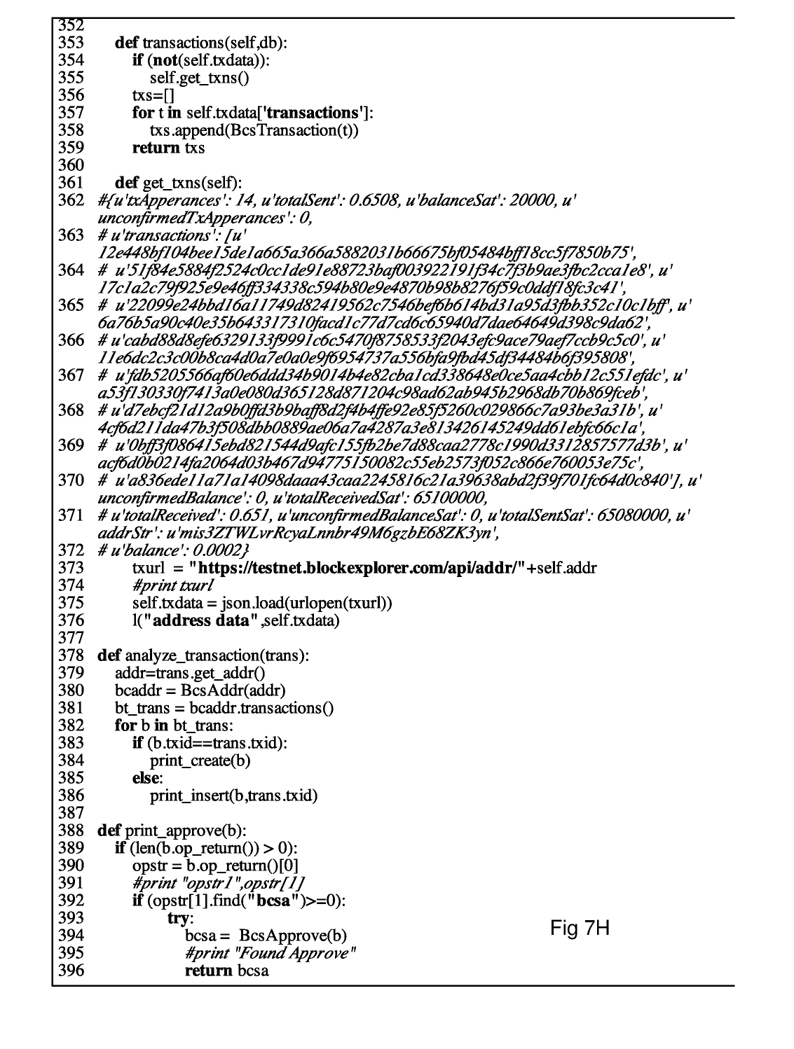

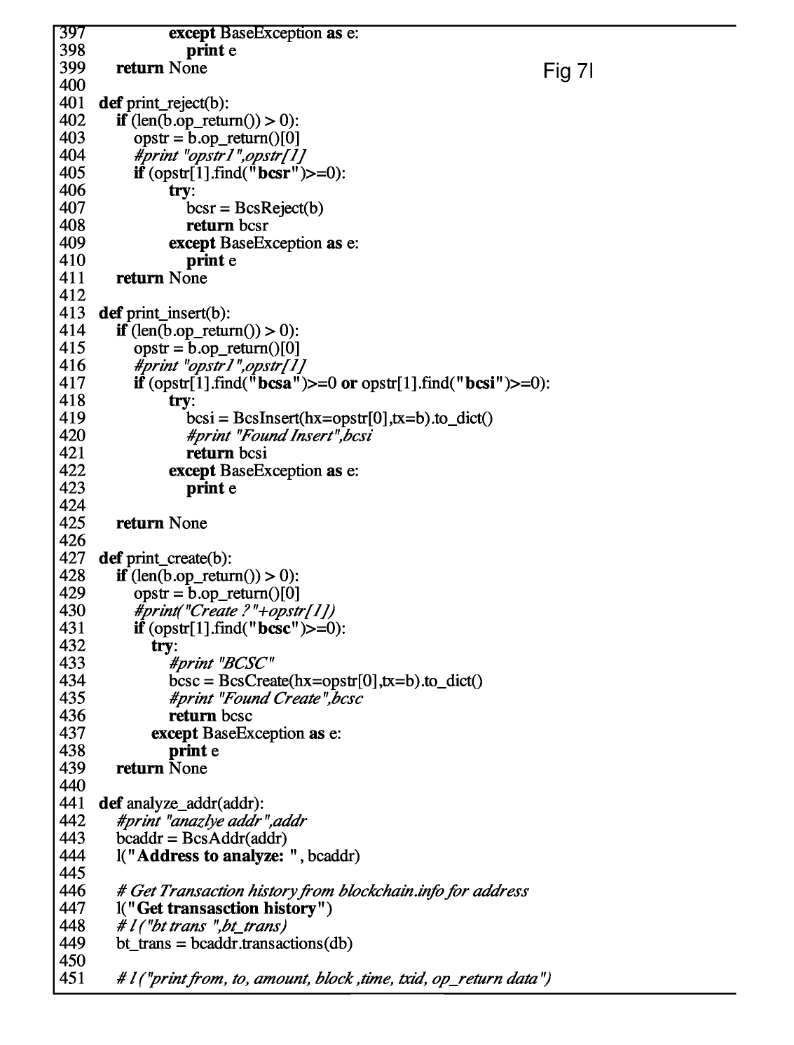

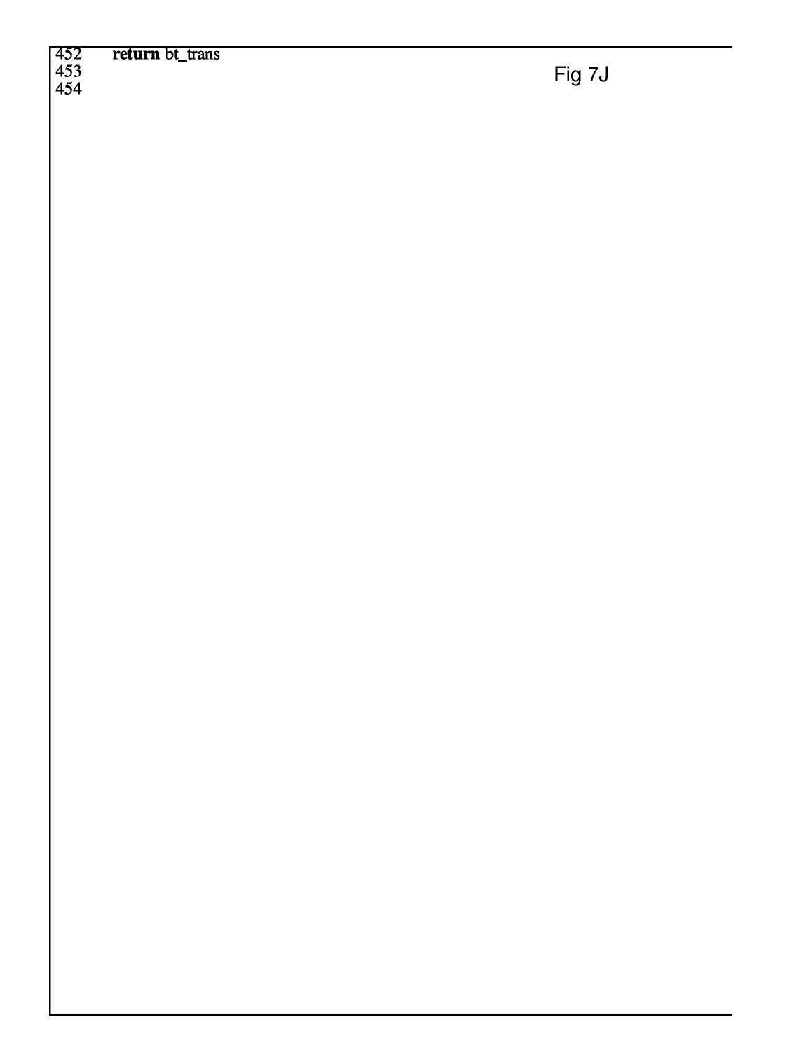

Chainset Messages

Chainset messages are generated by any user of the system and submitted, with appropriate transaction fees to the Bitcoin blockchain where they are globally distributed and inserted into blocks by users of that system.

Create

Create messages create a Chainset on the Bitcoin blockchain by submitting a specially crafted op_return message. This message is sent from the creator to himself with an adequate transaction fee given to Bitcoin miners. The format of the op_return message is as follows:

| | Auto- | Auto- | Propose | Reject | Approve | | Alter |
|---|---|---|---|---|---|---|---|
| Identifier | commit | commit | Payment | Payment | Payment | Documentation | Previous |
| bcsc | Unsigned | Integer | Integer | Integer | Integer | 28 bytes | 32 bytes |
| | Short | | | | | | |

Field Description

Identifier: This is a string prepended to every create transaction to identify it as being a Chainset Create message.

Auto-Commit Flag: 0 or 1—determines if this Chainset is an auto-commit Chainset.

Auto-Commit Timeout: Number of blocks to wait before automatically approving a propose messages Propose Payment: Payment made from proposer to creator for consideration of a proposal

Approve Payment: Payment made from approver to proposer in consideration for the approval of their message.

Reject Payment: Payment made from creator to proposer in consideration for rejecting their proposal.

Autoapprove, Autoapprove Timeout

Sets may be created as auto-approve sets in which the proposed item is automatically added to the set after a certain block height after the proposal is included in a block.

Microeconomic Considerations (e.g., SPAM Avoidance)

The propose fee may be set high to discourage spam. If the reject fee is set to a similar value to the propose value then the rejection payment can be made as a courtesy for a good faith submission that did not meet the Chainset creator's criteria. If the approve payment is set higher than the propose payment, the creator is indicating that he would like to compensate approved submissions.

Propose, Approve Reject Payment

The propose message is used by the proposer to propose to the creator that a new value should be included into the set of approved hashes in the Chainset. The propose command consists of a transaction id of the set creation and a 32 byte value submission, usually a hash of an object in a Distributed Object Store (DOS). It also includes 12 bytes of flags that can be used for application specific purposes. Along with the proposal, a payment is made to the creator. The propose payment is specified in the referenced create message sent to the blockchain earlier. The format of the op_return message is as follows

| Identifier | Txid of create message | Content Hash | Custom flags. |
|---|---|---|---|
| bcsp | 32 bytes | 32 bytes | 12 bytes |

Field Description

Identifier: This is a string prepended to every approve transaction to identify it as being a Chainset Approve Message

TxID: This is the blockchain transaction id of the original create message. Content: This is a 32 byte content hash value to be added to the Chainset

Custom Flags: This is 12 bytes of custom data that can be used in an application specific way.

Approve

The approve command is a cryptocurrency payment sent by the Chainset creator to the proposer with an approve payment indicating that the proposal has been approved and the value should be included in the set. It includes the transaction id of the creator's set, and the transaction id of the proposer's proposal, plus a few bytes for custom flags.

| Identifier | Txid of create message | Txid of insert message | Custom flags |
|---|---|---|---|
| bcsa | 32 bytes | 32 bytes | 12 bytes |

Reject

The reject command is sent as a payment from the Chainset creator's account to the proposer's account. It includes a reject payment indicating that the creator has rejected the proposer' proposal for inclusion of the block chain in the main chain.

| Identifier | Txid of create message | Txid of insert message | Custom flags |
|---|---|---|---|
| bcsr | 32 bytes | 32 bytes | 12 bytes |

Field Description

For approve and reject messages, the fields are similar.

Identifier: This is a string prepended to every approve transaction to identify it as being a Chainset Reject or Approve Message

TxID: This is the blockchain transaction id of the original create message.

Txid of Insert: This is a 32 byte transaction id of the message to be approved

Custom Flags: This is 12 bytes of custom data that can be used in an application specific way.

Command Sequence Examples

AutoApprove Set:
Create
Propose
(Approve II (Time Passes))
Reject (Optional)

Non-AutoApprove Set:
Create
Propose
Approve (Optional)
Reject (Optional)

Implementation

Block Chain Index Server

The blockchain index server reads through the blockchain and indexes Chainsets by creation transaction id. This allows for any client to quickly get a list of all transactions that apply to a set and to determine the current set composition.

Chainset Clients

Chainset clients create creation, proposal, approval, and rejection messages. They also read canonical sets from blockchain index servers and optionally use full blockchain nodes to verify the integrity of the set.

Content Hashes

Content hashes are what are proposed for inclusion in the Chainset. They are 32 bytes. They can be generated from a file, usually stored in a distributed object store file serving mechanism such as BitTorrent.

Wallet Integration

Creation of Chainset messages and querying of Chainset index servers would be a useful function to build into Bitcoin wallets as a user has to have access to a valid Bitcoin wallet to participate in sending Chainset messages.

Weaknesses

Wallets without their own full node are subject to the same kind of attacks as are present in SPV wallets, including omissions in the full set of wallet transactions if a relied upon index server decides to produce intentionally wrong index data.

Blocks can be rolled back in rare cases, readers of the blockchain can decide to wait for a certain number of confirmations before trusting the complete set of transactions. In non Auto-approve sets the Chainset owner may not approve or reject transactions at all. Thus, the expected monetary reward or penalty of the proposer will be uncertain in the case of a non-auto approve set.

Certain Chainsets may, at some point in the future, have certain miner nodes selectively refuse to process their transactions when the value of blocking the transaction is perceived as high to that person. Thus they will be able to force omissions of proposals, approvals or rejections. A similar ‘blacklisting’ potential exists with the Bitcoin cryptocurrency.

1. A peer based computer network for allowing a group of users to create, access and maintain a set of user data that has been approved and modified by said users, comprising
a fee based mechanism for submitting new data sets and proposed modifications to existing data sets and approvals of those new new data sets and proposed modifications by other users;
a distributed blockchain object store for storing different versions of said data sets;
means for generating data structures identifying each proposed modification and which proposed modification has been approved or rejected by which users; and
a chainset server that analyzes and summarizes the hash identified distributed object store to determine the current status of approvals and rejections and generate the latest approved versions of the user data sets.

2. The computer network of claim 1, wherein the fee based mechanism includes a proposal fee from the proposer to the creator, an approve fee from the creator to the proposer, and a reject fee creator to the proposer.

3. The computer network of claim 2, wherein the distributed blockchain object store includes a plurality of unrelated data sets and identifies which transactions apply to a particular data set, whereby a user may determine the current composition of a particular data set.
